(19) United States
(12) Patent Application Publication
(10) Pub. No.: US 2011/0113487 A1
(43) Pub. Date: May 12, 2011

(54) ICON CARD VERIFICATION SYSTEM

(76) Inventor: Conrad A. Miller, Kalkaska, MI (US)

(21) Appl. No.: 12/897,838

(22) Filed: Oct. 5, 2010

Related U.S. Application Data
(60) Provisional application No. 61/260,044, filed on Nov. 11, 2009.

(51) Int. Cl. H04L 9/32; B41J 2/00; G06F 21/00

(52) U.S. Cl. 726/19; 347/110

(57) ABSTRACT

An identity verification system uses a master key formed of first and second sets of symbols arranged in a one to one relationship. A distinct public key is assigned to each user of a plurality of users. A unique private key is established for each user and formed of at least some of the first symbols in the first set. The symbols of the private key for a user are placed in an arrangement where each first symbol is distinctly identifiable by a location. The first symbols in the arrangement are translated to a visual corresponding second symbol from the master key. Upon receiving the public key of one user, an identity validation challenge formed of at least two locations of the second symbols in the arrangement is presented to the user. The identity of the user is validated upon receiving the correct second symbols corresponding to the challenge locations.

### CROSS REFERENCE TO CO-PENDING APPLICATION

This application claims priority benefit to the Nov. 11, 2009 filing date of co-pending U.S. Provisional Patent Application Ser. No. 61/260,044, filed in the name of Conrad Miller for a “ICON CARD VERIFICATION SYSTEM”, the entire contents of which are incorporated herein by reference.

### BACKGROUND

The present icon card verification system relates, in general, to identity verification systems and, more particularly, to identity verification systems using key verification which can fit on the back of credit cards, identification cards and other types of media that require identity verification.

This identity verification system is proposed as a direct replacement to CVV found on the back of credit cards and personal questions. The credit card verification value as a security check is flawed considering after the first use of the credit card online a potential hacker or even an employee of a legitimate company has all of the information needed to commit fraudulent transactions.

So the first time the credit card is used it is essentially compromised. By only giving part of a larger key places anyone willing to commit fraud at the will of a random number generator and even though they may receive part of the key to complete a transaction their odds of being able to use that information at a later time is severely limited.

As for the personal questions asked either when calling in on a account at some company or that are asked when you login to a online bank account, these are ultimately compromised by the fact that people close to you know most if not all of the answers to these types of questions. To break the proposed system would require physical access.

Identity theft cost an estimated 56 Billion dollars a year in the US alone.

The credit card verification value or CVV found on the back of credit cards, as a security check, is flawed considering after the first use of the credit card online a potential hacker or even an employee of a legitimate company has all of the information needed to commit fraudulent transactions.

Personal questions asked either when calling in on an account or that are asked when a user logins to a online bank account are ultimately compromised by the fact that people close to the user know most of the answers to these types of questions. The request for the last four digits of a user's social security number is also flawed considering it does not change during the course of the user's entire life. A Security Token is a better option in every case. However, companies use personal questions because hardware security tokens are cost prohibitive.

Hardware Security Tokens for fraud prevention have already been proven successful. The problem is that to provide every end user with one would exceed the cost of the fraud.

### SUMMARY

A method for verifying identity comprises the steps of:

establishing a master key including a first set of first symbols, and a second set of second symbols, the first and second symbols arranged in a corresponding one to one relationship; assigning a distinct public key to each user of a plurality of users;

establishing a unique private key for each user formed of at least some of the first symbols in the first set;

placing the first symbols of the private key in an arrangement where each first symbol is distinctly identifiable by a location in the arrangement;

providing a visual translation of each first symbol in the arrangement with the corresponding second symbol in the master key;

upon identifying one user, issuing an identify validation challenge formed of locations of the one or more second symbols in the arrangement; and

validating the identity of a user upon receiving the correct second symbols corresponding to the challenge locations.

The method may also comprise the steps of forming the first symbols in the master key of alpha-numeric character; and forming the second symbols in the master key as icons.

The method in the step of establishing the private key may further include the step of establishing the private key as a variable length randomly generated private key of the first symbols.

In the method, the step of establishing the master key may further comprise the step of establishing the first set of first symbols as distinct alpha numeric characters.

The step of establishing the master key may further comprise the step of forming the first set of first symbols to include at least 10 distinct first symbols.

The step of providing a visual translation may further comprise the step of printing the visual translation on a portable planar member.

The method may further comprise the step of providing a distinct public key assigned to each user of the plurality of users; and wherein the step of identifying one user further includes the step of identifying the public key of the one user and using the second symbols in the identified user private key for the identity validation challenge.

The step of placing the first symbols of a private key in an arrangement may further comprise the step of placing the first symbols of the private key consecutively in a matrix of rows and columns, where each first symbol is distinctly identifiable by distinct row and column identifiers.

The step of identifying each user may include the step of assigning a distinct public key to each user of a plurality of users.

In the method, the steps of establishing a unique private key, placing the first symbols of the private key in an arrangement and providing a visual translation of each first symbol in the arrangement with a corresponding second symbol in the master key are performed by one entity and the steps of issuing a validation challenge and validating the identity of a user as performed by a separate entity.

In one aspect, a method for verifying identity using a master key establishing a master key including a first set of first symbols and a second set of second symbols, the first and second symbols having a corresponding one to one relationship, a unique private key established for each user and formed of at least some of the first symbols in the first set, where the first symbols of the private key are placed in an arrangement, and where each first symbol is distinctly identifiable by a location in the arrangement, and providing a visual translation of each first symbol in the arrangement with the corresponding second symbol in the master key, the method comprises the steps of:

upon identifying one user, issuing an identify validation challenge formed of at least two of the locations of the second symbols in the arrangement;

and validating the identity of a user or upon receiving the correct second symbols corresponding to the challenge locations.

### BRIEF DESCRIPTION OF THE DRAWING

The various features, advantages and other uses of the present invention will become more apparent by referring to the following detailed description and drawing in which:

FIG. 1 is a pictorial representation of one example of a master key used in the present identity verification system;

FIG. 2 is a pictorial representation of a private key mapped into a private key display matrix;

FIG. 3 is a pictorial representation of the private key shown in FIG. 2 translated into the master key icons;

FIG. 4 is a pictorial representation of a different private key display matrix example on the back of a credit card;

FIGS. 5 and 6 are pictorial representations of a challenge form used in the present identity verification system; and

FIG. 7 is a table depicting an example of the first and second symbols in Master Key.

### DETAILED DESCRIPTION

The primary purpose of the icon card verification system is to create a human readable verification system using randomly generated keys. The private keys could be sized to fit on the back of a credit card, identification card or in any other type of system that requires identity verification.

The present icon verification system uses, a Master Key, a Public Key, account a Private Key, a Public Key account number to link a user identity to a Private Key and partial key verification to verify the identity of a user of a service, such as a user of a credit card or a user submitting an identification card to permit entrance into a facility, to acquire a product or service, for entry at a national border crossing etc.

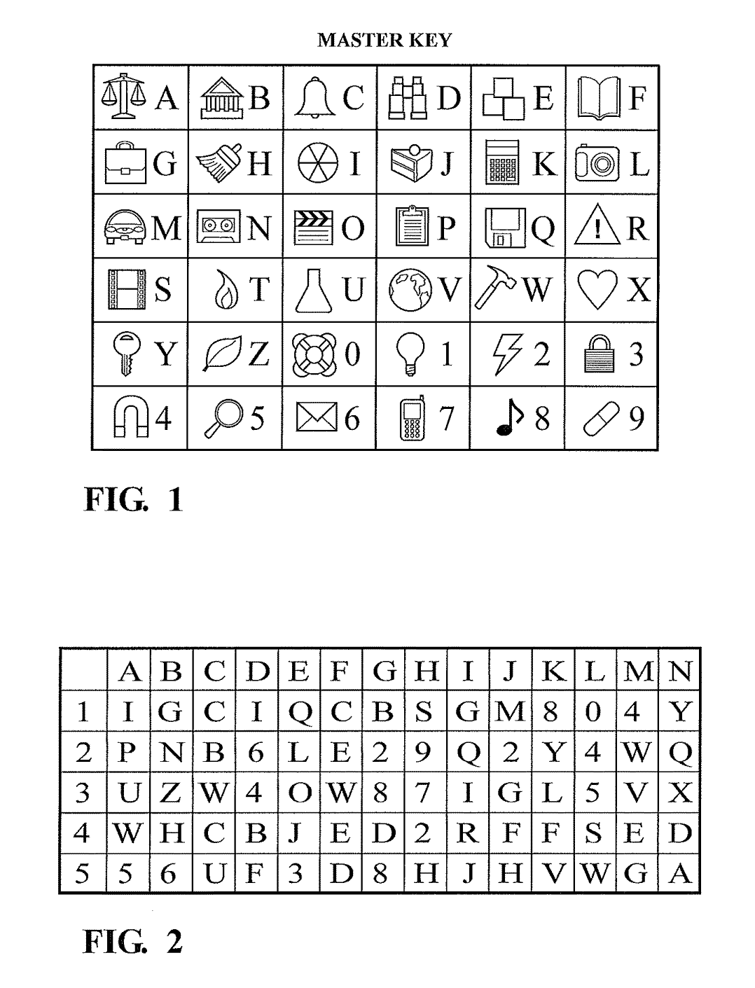

Referring now to FIG. 1 there is depicted an example of a Master Key. The Master Key is used to translate ABCDEFGHIJKLMNOPQRSTUVWXYZ0123456789 (Base36) into icons for the purpose of generating visual private keys for identity verification. Master Keys are not limited to this precise arrangement and could be themed differently or expanded to larger bases. Forming a base 36 alphanumeric master key is by way of example only as any alphabetic letter, numeral or alphanumeric combinations thereof can be used in any length base to form the Master Key. It will be understood that the Master Key could be a base 26 set of 26 alphabet letters. A base 100 master key could consist of the numerals 1-100. For a significantly large issuer, the icons could be replaced with brand logos and sold as advertisements, thereby reducing or eliminating the overall cost of implementation.

The Public Key or CardID is a unique, identifier used by the issuer to link a user identity or account to Private Key. It could be just numeric for easy registration over the telephone when receiving a new credit card. The public key could also be an account number, a social security number or some other identifier. The Public Key can be a barcode printed along the bottom of a credit card or access card. Such a barcode is compatible with swipe style barcode readers. This feature allows the cards to be preprinted and distributed. The secured icon cards can be marketed as a stand alone security product without knowing their end use. The issuer can brand the card and then print an account at a later time. Another example of a Public Key is 0000000000000215 as shown in FIG. 4.

The Private Key is a unique, variable length, randomly generated key that is translated to a custom visual lexicon using icons. When a Private Key is created, there are only two copies. One is a digital copy stored in a gateway or master database and the other is an analog copy printed on the back of a user issued card. The data contained in the visual key is not is not encoded in the magnetic strip on the card. One example of a Public Key is 3TR3-BZ6C. Using only 8 digits, a base 36 string can represent over 76 billion unique combinations.

Another example shown below could be printed on the back of a credit card and/or fit under the magnetic stripe. The number of possible unique Private Keys is a length of the Private Key to the power of the size of the Master Key. In this example, that would be 2.651×10⁶⁹.

Private Key Example: IGCIQBGSGM804YPNB6LE29Q2Y4WQUZW4OW87IGL5VXWHCBJED2RFFSED56UF3D8HJHVWGA

If the full back or front of a credit card is utilized, it is possible to fit over 112 legible squares on a standard size ISO 7810 card.

The Private Key can use some or all of the symbols in the Master Key. The Private Key can also use each master key symbol more than once to generate (40³⁶) possible private keys in this example. A more generic formula to calculate the number of possible private keys would the number of icons to the power of squares used in the matrix.

Each letter, number or symbol within the private key is mapped into an arrangement where each location containing a number, letter or symbol, etc., is uniquely identifiable or addressable. The arrangement can be a square or rectangular, matrix-like table, Columns are labeled with letters and rows are labeled with numbers or vice-versa, for example, like an Excel spread sheet. Other arrangements, including a single straight line arrangement, circular arrangement, etc., can also be employed as long as each location containing a letter, number or symbol of the Private Key can be uniquely identified or addressed. In arrangement formed as a matrix, the columns could have numbers and the rows letters. So in this example, the first letter in the Private Key “I” is in the location of A1. The second letter “G” is in the location of B1 and so on.

The 5×14 matrix is by way of example only as the numbers of rows and columns in the matrix is chosen to suit the size and shape of an identification, credit card, etc.

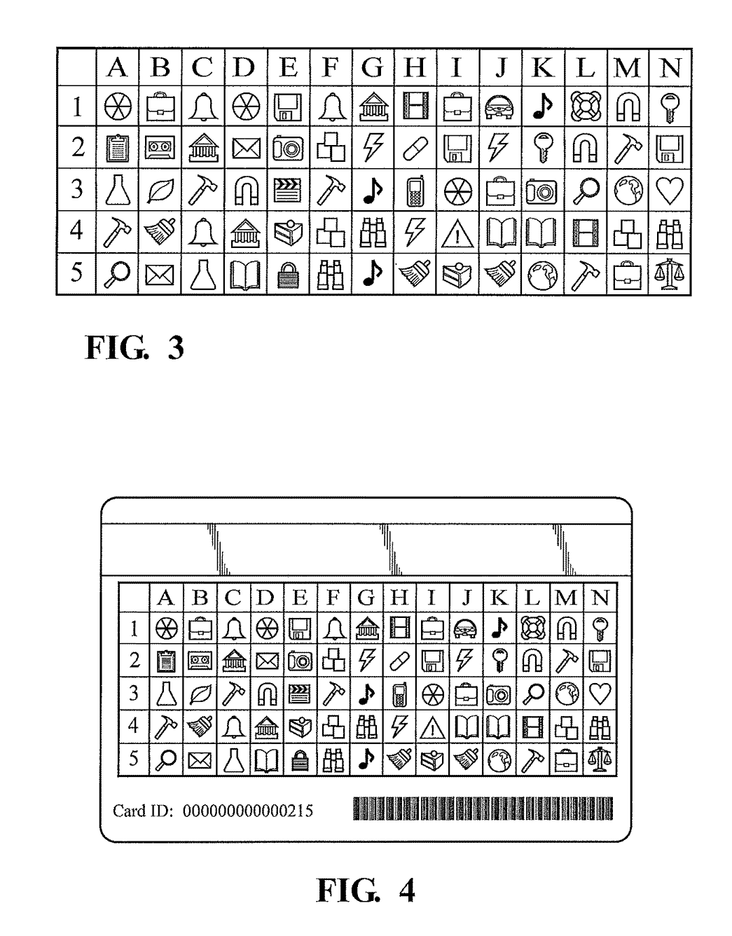

The matrix shown in FIG. 2 is transformed to a visual, icon Private Key display shown in FIG. 3 by mapping the icons from the Master Key into the icon matrix which correspond to the symbols in the matrix shown in FIG. 2. This example was generated by replacing each letter in the Private Key with the matching icon from the Master Key as shown in FIG. 3. The matrix shown in FIG. 3 is the private key of an individual.

FIG. 4 depicts the Private Key shown in FIG. 3 placed on the back of a credit card along with a Public Key account number.

When an entity or user claims a Public key as its identity, the user can be verified by issuing a partial key challenge. The odds of getting the same challenge on verification request can be calculated by the formula:

$$\frac{n !}{r ! ( n - r ) !} = ( \begin{matrix}n \\ r\end{matrix} )$$

Where n is the number of squares on the card, and the gateway is requesting r of them. This function calculates permutations with no'repetition and order doesn't matter also know as combinations. Using 70 Squares and 2 Locations at a time=2415. In the case that part of the key is compromised, the over all integrity of the system is still maintained.

If no part of the key has been compromised then the odds of guessing any one challenge is the base of the master key to the power of the number of requested squares for verification, eg., 36²¹ or 36³¹⁾. As the number of squares requested increase so does the improbability of guessing the challenge; but if unauthorized parties are eavesdropping the number of transactions needed to reverse engineer the entire key would decrease. A real world example of this process would be to imagine a consumer buying one item per day online and a hacker has installed a key logger on their computer. It would take a month to figure out the entire key and impersonate the victim 100% of the time

The challenge would be a random selection of at least one or two or more locations on the private key.

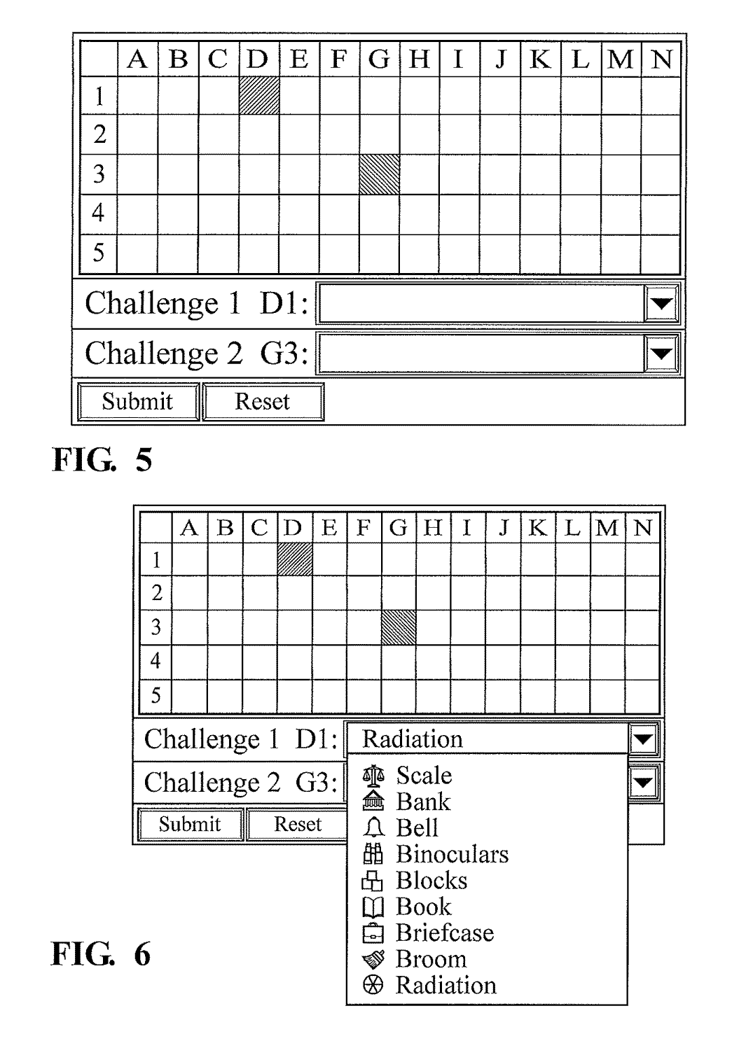

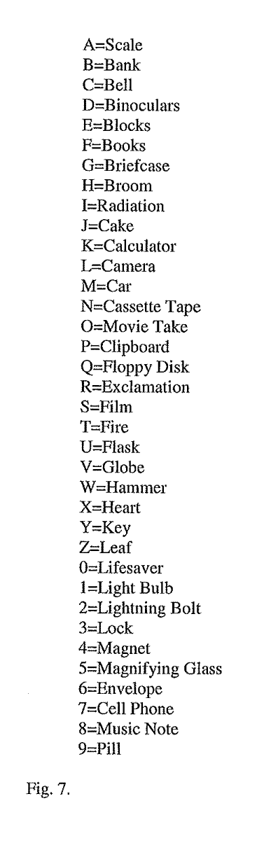

Challenge example: D1-G3. The user challenge answer area for a web page form is shown in FIGS. 5 and 6.

The user presented with this challenge would look at his or her Private Key and respond by identifying the icon found in the requested location from a list of all possible icons. The response can be handled through a form on a web page shown in FIGS. 5 and 6. The response would then be securely relayed to the gateway over the Internet for verification. The user could also verbally respond to the challenge by saying “radiation and light”.

A verification gateway would need to be implemented in any system that would use this partial key verification. The process would work as follows:

Request Public Key 000 . . . 000215.

Send Challenge D1-G3 (Even if the public key is invalid).

Request Answer I-8 (Radiation and Music Note). and Send Challenge Response True Or False and, optionally, a time stamped authorization or approval code for future reference.

Other security features could be designed into the gateway, such as limiting the number of failed attempts over a given amount of time. This would prevent a brute force attempt at guessing every possible answer.

A Private Key can be placed on a number of different items, such as a driver's license, credit cards, social security cards, passports, player club cards and employee badges.

The verification system using the Master Key and Private Key can be used in a number of different applications, such as online transactions, card not present transactions, identity protection, online login, PIN transactions, Medicare insurance claims, Military identification, secure voting, and any system requiring remote validation

This system used with social security cards and legislation requiring third party validation of any large transaction would completely eliminate any possibility of identity theft. Another effect would be to allow social security numbers to become Public Keys considering it could not be used without its Private Key counterpart. Then only the Private Key would need to be protected not the Public Key. With a Private Key validation system, a user does not care about the Public Key as it is only a reference and is not self validating. In the case of a lost or stolen private key a new one could be created and the Public Key could remain the same.

The over all impact of data breaches could be minimized considering the Private Key data would not be stored with the account information. Now the information obtained may expose the link between an account number and the Public Key. But the Private Key would still only exist on the end user's card and in the gateway database.

There may also be a use for these keys as they can replace OTP (one time password) Security Tokens. A router could be setup to link CardID's to a user, then communicate with the gateway for verification. In the cases where remote access is only needed periodically, a key could be activated and issued to an employee and set to automatically expire after the need for remote access is over. Paper keys could be sold in bundles and discarded after use.

The system is a “man in the middle” resistant because the random request from the gateway is unknown. Although through eavesdropping in on enough challenge response sessions the Private Key could eventually come to be known. In the area of credit card fraud the pieces of the key would most likely be disbursed among non-communicating parties. In other words, each potential “man in the middle” would have to learn the entire key on his own. This would require many transactions with the same company or eavesdropping on all communication of the victor for a sufficient amount of time.

By giving only part of a larger key, anyone willing to commit fraud at the will of a random number generator. Even though they may receive part of the key to complete a transaction; their odds of being able to use that information at a later time is severely limited.

Only the Private Key needs to be protected. The Public Key is only a reference and is not self validating. Since this system is based on random keys there is no algorithm to hack. The security is encapsulated and provided by probability

The cost of implementing this system could be reduced further by selecting a different medium than a PVC credit card. There is no reason that paper could not be used. The only question is of durability and how long the key needs to last. These keys could be manufactured for less than a cent per key using high quality paper and a color digital press.

What is claimed is:

1. A method for verifying identity comprising the steps of:
establishing a master key including a first set of first symbols and a second set of second symbols, the first and second symbols having a corresponding one to one relationship;
assigning a distinct public key to each user of a plurality of users;
establishing a unique private key for each user formed of at least some of the first symbols in the first set;
placing the first symbols of the private key in an arrangement where each first symbol is distinctly identifiable by a location in the arrangement;
providing a visual translation of each first symbol in the arrangement with the corresponding second symbol in the master key;
upon identifying one user, issuing an identify validation challenge formed of at least one location of the second symbols in the arrangement; and
validating the identity of a user or upon receiving the correct second symbols corresponding to the challenge location.

2. The method of claim 1 further comprising the step of:
forming the first symbols in the master key of alpha-numeric characters; and
forming the second symbols in the master key as icons.

3. The method of claim 1 wherein the step of establishing the private key further comprises the step of:
establishing the private key as a variable length, randomly generated private key of the first symbols.

4. The method of claim 1 where the step of establishing the master key further comprises the step of:
establishing the first set of first symbols as distinct alpha numeric characters.

5. The method of claim 1 wherein the step of establishing the master key further comprises the step of:
forming the first set of first symbols to include at least 10 distinct first symbols.

6. The method of claim 1 wherein the step of providing a visual translation further comprises the step of:
printing the visual translation on a portable planar member.

7. The method of claim 1 further comprising:
the step of providing a distinct public key assigned to each user of the plurality of users; and wherein:
the step of identifying one user further includes the steps of:
identifying the public key of the one user; and
using the second symbols in the identified user private key for the identity validation challenge.

8. The method of claim 1 wherein the step of placing the first symbols of placing a private key in an arrangement further comprises the step of:
placing the first symbols of the private key consecutively in a matrix of X rows and Y columns, where each first symbol is distinctly identifiable by distinct row and column identifiers.

9. The method of claim 1 wherein the step of identifying each user comprises the step of:
verifying the distinct public key assigned to the user requiring identification.

10. The method of claim 1 wherein:
the steps of establishing a unique private key, placing the first symbols of the private key in an arrangement and providing a visual translation of each first symbol in the arrangement with a corresponding second symbol in the master key are performed by one entity; and
the steps of issuing a validation challenge and validating the identity of a user as performed by a separate entity.

11. The method of claim 1 wherein the step of issuing an identity validation challenge comprises the step of:
issuing an identity validation challenge formed for at least two locations of the second symbols in the arrangement.

12. In a method for verifying identity using a master key including a first set of first symbols and a second set of second symbols, the first and second symbols having a corresponding one to one relationship; assigning a distinct public key to each user of a plurality of users; a unique private key established for each user and formed of at least some of the first symbols in the first set and where the first symbols of the private key are placed in an arrangement where each first symbol is distinctly identifiable by a location in the arrangement, and providing a visual translation of each first symbol in the arrangement with the corresponding second symbol in the master key, the method comprising the steps of:
upon identifying one user, issuing an identify validation challenge formed of at least one of the locations of the second symbols in the arrangement; and
validating the identity of a user or upon receiving the correct second symbols corresponding to the challenge location.
